(19) United States
(12) Patent Application Publication
(10) Pub. No.: US 2005/0008155 A1
(43) Pub. Date: Jan. 13, 2005

(54) Secure digital transmitter and method of operation

(75) Inventors: Christopher M. Durso, Carlsbad, CA (US); Alex David Dirdo, Vista, CA (US)

Correspondence Address: CLIFFORD B. PERRY, 449 SANTA FE DR, #312, ENCINITAS, CA, 92024, US

(73) Assignee: Pacific Microwave Research, Inc., Vista, CA (US)

(21) Appl. No.: 10/742,068

(22) Filed: Dec. 18, 2003

Related U.S. Application Data
(60) Provisional application No. 60/485,913, filed on Jul. 8, 2003.

(51) Int. Cl. H04N 7/167

(52) U.S. Cl. 380/212

(57) ABSTRACT

A secure transmitter capable of reliably communicating secure data within a heavily multi-path environment includes a data compression module, an encryption module, and a coded orthogonal frequency division multiplex module. The data compression module receives and compresses input video data to a predefined bandwidth, outputting the video data in a transport stream. The encryption module receives and applies a data encryption algorithm to the transport stream, outputting an encrypted transport stream in response. The coded orthogonal frequency division multiplex module receives the encrypted transport stream and produces, in response, an output signal comprising a plurality of sub-carriers, each sub-carrier modulated by data of the encrypted data stream.

### CROSS REFERENCE TO RELATED APPLICATIONS

This application claims the benefit of U.S. Provisional Application no. 60/485,913, entitled “Secure Digital Radio Frequency Transmitter,” filed Jul. 8, 2003, the contents of which are herein incorporated by reference in its entirety for all purposes.

### BACKGROUND

The present invention relates generally to systems and methods for transmitting data, and more specifically to systems and methods for reliably transmitting secure data in multi-path environments using radio frequency techniques.

The present invention was borne from the requirement to reliably deliver secure information in a heavily multi-path environment. A heavily multi-path environment is one that contains a significant number of buildings, walls, floors, vehicles and other obstructions that could potentially result in numerous reflections of the transmitted signal. Heavily multi-path environments may exist, for example, when attempting to transmit signals within a building, between buildings, to/from a cellular phone or other mobile device within an urban area, or on a battlefield when numerous vehicles or obstructions are in the surrounding area. When the transmitted signal is reflected, it arrives as the receiver out of phase relative to an un-reflected signal. If numerous reflections occur, the reflected wave will increasingly approach a point where it is 180 degrees out of phase with an un-reflected signal, at which point the two signals will destructively interfere, causing the receiver lose the signal. For mobile users, these drop-outs will occur repeatedly as the user moves through the environment. The loss of the transmitted signal, especially when secure data is being communicated, cannot be tolerated in most instances.

Therefore what is needed is an improved transmitter capable of communicating secure data in a heavily multi-path environment without data loss.

### SUMMARY OF THE INVENTION

The present invention provides a transmitter system and methods for communicating secure data within heavily multi-path environments without data loss. Data is initially compressed and multiplexed on a transport stream. The transport stream is subsequently encrypted. Immunity to signal multi-path is provided by applying coded orthogonal frequency division multiplexing (COFDM) to the encrypted transport stream. The resulting signal is then modulated onto a carrier signal and transmitted to one or more receivers.

These and other features of the invention will be better understood when viewed light of the following drawings and detailed description.

### BRIEF DESCRIPTION OF THE DRAWINGS

FIGS. 1A and 1B illustrate a secure transmitter and method of operation, respectively, in accordance with one embodiment of the present invention.

FIG. 2 illustrates an exemplary embodiment of the data compression module shown in FIG. 1A.

FIG. 3 illustrates an exemplary embodiment of the encryption module shown in FIG. 1A.

FIG. 4 illustrates an exemplary embodiment of the COFDM module shown in FIG. 1A.

FIG. 5 illustrates an exemplary embodiment of the transmit module shown in FIG. 1A.

FIG. 6 illustrates a block diagram of a personnel rapid deployment system in accordance with the present invention.

For clarity and convenience, features and components in earlier drawings retain their reference numerals in subsequent drawings.

### DETAILED DESCRIPTION

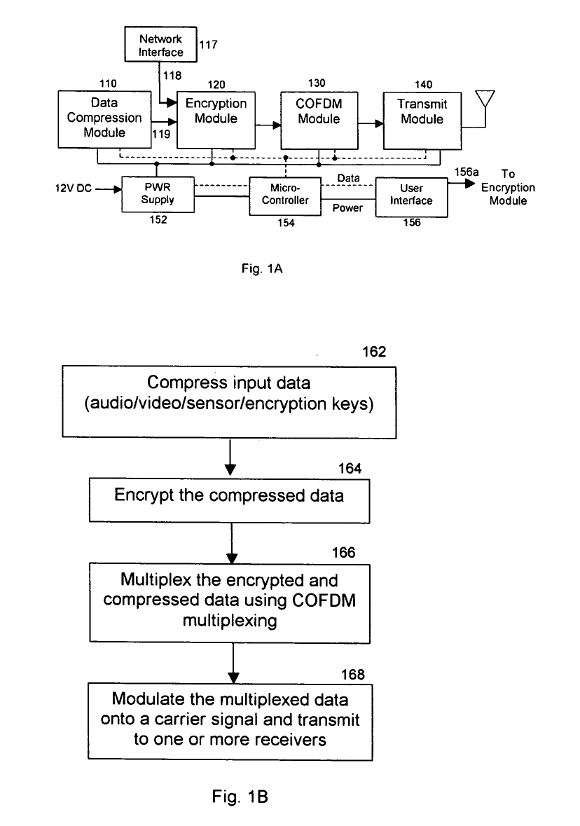

FIGS. 1A and 1B illustrate a secure transmitter and method of operation, respectively, in accordance with one embodiment of the present invention. Referring to FIG. 1A, the secure transmitter 100 includes a data compression module 110, a network interface 117, an encryption module 120, a coded orthogonal frequency division multiplex (COFDM) module 130, a transmit module 140, a power supply 152, a microcontroller 154, and a user interface 156. Specific embodiments of the data compression module 110, encryption module 120, coded frequency division multiplex module 130, and transmit module 140 are shown and described below. Power supply 152 provides regulated power to each of the modules 110-140, as well as to a microcontroller 154 and user interface 156. Microcontroller 154 is further connected to, and controls the operation of modules 110-140, power supply 152 and user interface 156. User interface 156 provides a means for inputting information, such as selecting or modifying certain parameters of the transmission, and/or means for outputting information e.g., a display screen integrated thereon, or an interface for outputting user interface data 156a. Power supply 152 operates to regulate and provide power from any power source (fixed or portable), exemplary power supplies including line voltage connections, batteries or other low voltage sources, and the like.

Referring now to FIG. 1B, the operation of the secure transmitter will now be described. Initially at 162, input data is supplied to the system and compressed. This process can be accomplished by means of the data compression module 110 which operates to reduce the bandwidth of certain supplied signals (e.g., audio and/or video signals) to a fraction of their original bandwidth. The input data may consist of audio signals, video signals, signals from other sensors (electronic, radiologic, chemical, bio-electronic, etc.) in either analog or digital formats. The video data may comprise imaged data in the visible spectrum as well as in other regions (e.g., infrared, RF, etc). In a specific embodiment, the video data uses a standard format, such as NTSC, SECAM, PAL, RS-170, or composite signal formats, although any format which can be processed by the system may be used in an alternative embodiment under the present invention.

Alternatively or in addition, input data may also be supplied to the system by means of a network interface 117 which is adapted to convert received network data to a format and protocol required by the encryption module 120. As used herein, the term “network data” refers to data which is typcially communicated across a wireline or wireless network, some examples being IP packets (TCP/IP, UDP/IP) ATM cell streams, serial byte streams, file(s) in a shared storage medium, Fiber Distributed Data interface (FDDI) data streams, SCSI command and data streams. Those skilled in the art will appreciate that the foregoing data formats are only exemplary of those communicated across a network, and that data of any particular format may be used in alternative embodiments under the present invention.

In a specific embodiment of the invention, encryption data is also received as input data (e.g., via the user interface 156). In a specific embodiment of the invention, the encryption data includes one or more keys or codes, an example of which would include a network key and a user-selectable key. The network key insures that receivers outside of the user's network will not be able to decipher transmissions, regardless of the user-selectable key used. The user-selectable key provides the option of intra-network security, in that network receivers not provided with the correct user-selectable key will not decipher the transmission. In a further specific embodiment, this intra-network security feature can be overridden by providing the network key. Such a system may be advantageous, for example, in emergency situations where communication between different agencies (e.g., fire, police, Department of Homeland Security) is needed across the same network.

Next at 164, the input data (network data 118, and/or compressed data 119, and/or user interface data 156a) is encrypted. In the illustrated embodiment, encryption is performed through the application of an encryption algorithm using the input encryption data, which, in one embodiment would comprise the combination of the network and user-selectable keys. Further specifically, the encryption algorithm used is based upon the Advanced Encryption Standard (AES), a U.S. Federal Information Processing Standard adopted by the National Institute of Standards and Technology (NIST) to protect sensitive government information. Other encryption protocols such as the Triple Data Encryption Standard (3DES) may be used as well. Those skilled in the art will appreciate that the invention is not limited to a particular encryption standard, and other encryption standards may be used equally as well in alternative embodiments under the present invention.

Subsequently at 166, the compressed and encrypted signal is multiplexed using coded orthogonal frequency division multiplexing. Specifically, the compressed and encrypted signal is modulated onto a plurality of substantially orthogonal sub-carriers, and those modulated sub-carriers combined to form a composite signal. Next at 168, the composite signal is modulated onto a carrier signal for transmission to one or more receivers. The systems operable to carry out these functions are further illustrated and described below.

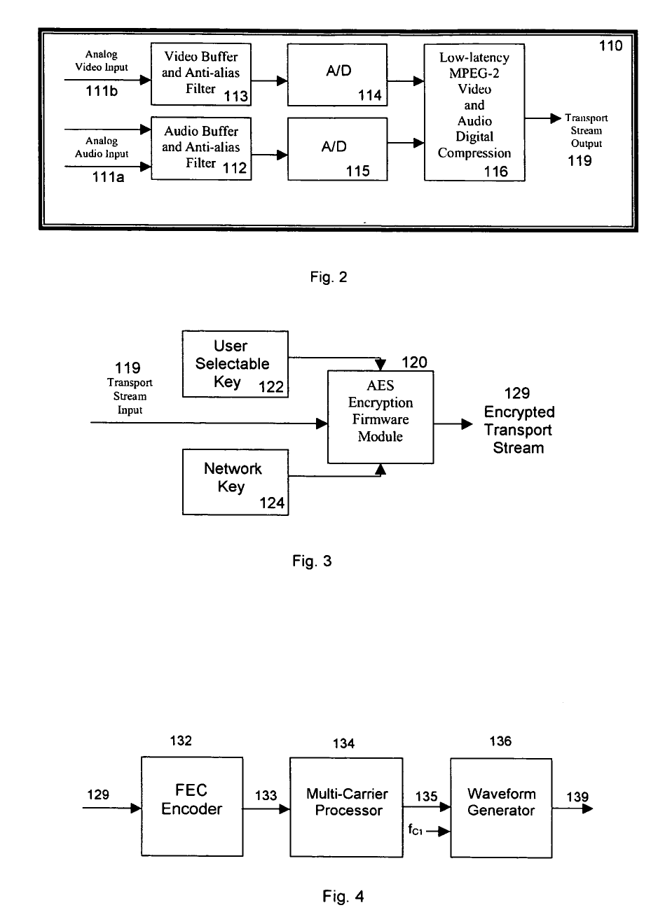

FIG. 2 illustrates an exemplary embodiment of the data compression module 110 shown in FIG. 1A. The data compression module 110 includes buffers and anti-aliasing filtering 112 and 113 operable to condition the supplied audio and video signals 111a and 111b. In a particular embodiment, the audio signal 111a includes two audio channels, the bandwidth of each generally in the range of 10 Hz-20 KHz. The supplied video signal 111b comprises a bandwidth conventional with its format, i.e., 6 MHz for a NTSC signal, 8 MHz for PAL, etc. The conditioned audio and video signals are then converted into digital signals via respective analog-to-digital converters 114 and 115. While the audio and video signals 111a and 111b are described as analog signals, one or both may be supplied in digital form, in which case the buffers and anti-aliasing filters 112/113, and analog-to-digital converters 114/115 may be omitted.

The digitally formatted video and audio signals are input to a data compression circuit 116, which produces, in response, a transport stream 119 containing the compressed audio and video information. In a particular embodiment, the data compression circuit 116 employs the MPEG-2 compression standard using a low latency implementation. To achieve similar low latency affects, the MPEG-2 coding algorithm may be limited to intra (I) and predicted (P) pictures, and bi-directional pictures and/or interpolation may be omitted. In this embodiment, the collective bandwidth of the transport stream audio and video data is compressed to less than 5 Mb/s. Of course, these and other features available in the MPEG suite may be employed in other embodiments of the present invention. Further, while the supplied signals comprise audio and video information, other types of information may be provided alternatively or in addition to these. The term “transport stream” is used as a general term to refer to the data output from modules 110-140, and does not indicate any particular data format.

FIG. 3 illustrates an exemplary embodiment of the encryption module 120 shown in FIG. 1A. The encryption module 120 comprises an AES module which receives the compressed data comprising the transport stream 119, a user-selectable key 122, and a network key 124. In the particular embodiment illustrated, the AES module 120 comprises firmware which uses the Advanced Encryption Standard to encrypt the input data (network data 118, and/or compressed data 119, and/or user interface data 156a) using user-selectable key 122 and the network key 124, to produce an encrypted transport stream. As noted previously, the invention is not limited to the use of a particular encryption standard, and any standard may be employed in alternative embodiments. Further, one or both of the network or user-selectable keys may be omitted in the encryption process in alternative embodiments.

FIG. 4 illustrates an exemplary embodiment of the COFDM module 130 shown in FIG. 1A. The COFDM module 130 includes a FEC-encoder 132, a multi-carrier processor 134, and a waveform generator 136.

The FEC-encoder 132 receives the encrypted transport stream 129, and applies a forward error correction (FEC) algorithm thereto to produce an FEC-encoded transport stream 133. Any FEC coding may be employed, some examples being Convolution coding, Reed-Solomon coding, Bose-Chaudhuri-Hocquenghem (BCH) coding, Turbo coding, and the like. Additionally, a data interleaver (not shown) may be used to further encode the data and provide greater immunity to noise and drop-outs. Further, a cyclic prefix module may be implemented to decrease the effects of intersymbol interference that may occur when receiving reflected signals of large amplitudes. In such embodiments, the cyclic prefix module operates to prepend to each symbol comprising the composite digital signal, a 1/32, 1/16/, 1/8, or ¼ portion of that symbol's length, the prepended length operating as a guard interval to combat the aforementioned effects.

In a particular embodiment, the FEC-encoded transport stream 133 is converted to a plurality of parallel streams, each supplying FEC-encoded data to the multi-carrier processor 134. The multi-carrier processor 134 generates a plurality of substantially orthogonal sub-carriers and modulates each by the supplied FEC-encoded data to produce a respective plurality of modulated sub-carriers. The plurality of modulated sub-carriers are subsequently combined/serialized (within the multi-carrier processor 134 or external thereto) to form a composite signal 135, the composite signal 135 representing the collective spectrum of modulated sub-carriers. In a particular embodiment, the composite signal 135 is realized as two parallel data streams, an I data stream consisting of I (in-phase) terms, and a Q data stream consisting or Q (quadrature phase) terms.

In a particular embodiment, the multi-carrier processor 134 comprises firmware which executes an Inverse Discrete Fourier Transform (IDFT), and in a more specific embodiment, an Inverse Fast Fourier Transform (IFFT) to generate the substantially orthogonal sub-carriers. The number of sub-carriers generated can vary depending upon the noise immunity and modulation error ratio (MER) desired, may be a number comprising power of 2 for faster FFT computational speed, and is typically greater than 200. For example, the number of sub-carriers may range from 250 to 10,000, and in exemplary embodiments comprise 1,705 sub-carriers (as known in a 2 k or 2048 FFT size sub-carrier system) or 6,817 sub-carriers (as known in an 8 k or 8192 FFT size sub-carrier system).

Furthermore, any type of modulation may be used in modulating segments of the FEC-encoded transport stream 133 onto the sub-carriers. Exemplary modulation formats include phase shift keying and amplitude modulation, specific examples of which include bipolar and quadrature phase shift keying, and 16 point (QAM-16) and 64 point (QAM-64) quadrature amplitude modulation formats, respectively. These modulation techniques are only exemplary, and those skilled in the art will readily appreciate that any modulation format may be used in alternative embodiments under the present invention.

Next, the composite signal 135 (in the form of I and Q data streams in one embodiment) and a first carrier signal f_{c1} are supplied to the waveform generator 136. Therein, the I and Q data streams are modulated onto the first carrier signal f_{c1}, producing the output signal 139.

Depending upon the signal characteristics of the output signal 139 (e.g., frequency, power, etc.), it may be communicated to one or more receivers without further signal conditioning in accordance with the present invention. In such an instance, the frequency of the output signal 139 may be selected to be any frequency appropriate for the application, the selection being dependent upon various factors, including desired transmission bandwidth and range, power consumption, regulatory allocations, and environmental factors. In a particular embodiment, the frequency of the output signal ranges from 50 MHz to 50 GHz, including operation within the P, L, S and C bands, and in more particular embodiments, within the 1 GHz to 6 GHz frequency range. Further, the transmission bandwidth may also be made variable, ranging from 100 KHz to 100 MHz, and more in more particular embodiments, from 1 MHz to 10 MHz.

In another embodiment, the output signal 139 is further conditioned by means of a transmit module 140 to provide signal power level, transmission frequency, and/or other signal characteristics that are desired prior to transmission.

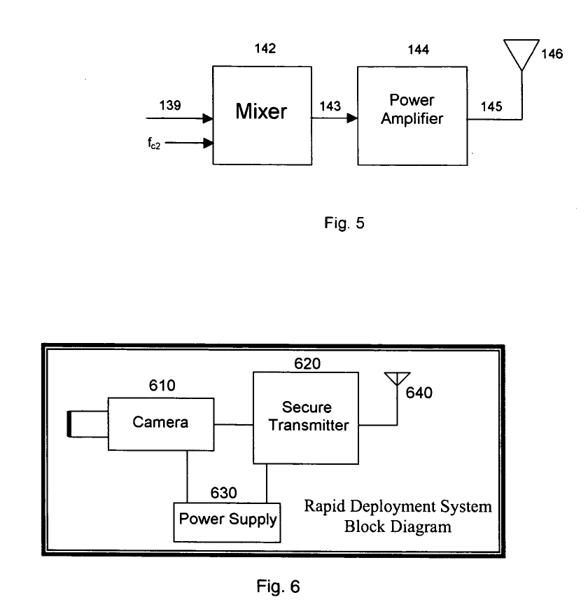

FIG. 5 illustrates an exemplary embodiment of the transmit module 140 shown in FIG. 1A. The transmit module 140 includes a mixer 142, power amplifier 144, and antenna 146. The mixer 142 receives a second carrier signal f_{c2} and converts the output signal 139 (up or down in frequency) to a second output signal 143. The second output signal 143 is supplied to the power amplifier 144, after which the amplified signal 145 is transmitted from the antenna 146 to one or more receivers.

As noted above with regard to the frequency of the output signal 139, the carrier frequency f_{c2} of the second output signal 143 may be any frequency appropriate for the application and conditions. In a particular embodiment, the frequency of the second output signal 143 ranges from 50 MHz to 50 GHz, including P, L, S and C bands, and in more particular embodiments, from 1 GHz to 6 GHz. Further, the transmission bandwidth may also be made variable, ranging from 100 KHz to 100 MHz, and in more specific embodiments from 1 MHz to 10 MHz. The particular power amplifier and antenna selected will in turn depend upon the carrier frequency chosen, and the aforementioned factors. In a typical embodiment, the power amplifier 144 will be selected to provide 1 mW to 10 W output power, and in more particular embodiments from 50 mW to 1 W output power at the carrier frequency. The antenna 146 selected may be of a directional or omni-directional type, and is most preferably of a form having the smallest cross-sectional area and weight associated therewith.

The secure transmitter has particular applicability in the areas of Homeland Security, law enforcement, military, intelligence, as well as in commerce when the reliable transmission of secure information is required. The secure transmitter provides a way by which users can securely transport information, e.g., audio and/or video information, for investigative, forensic, intelligence and First Responder applications in Homeland Security. The secure transmitter can provide point-to-point or point-to-multipoint transmission capability due to the digital transmission implementation, and can be placed in the environment on a temporary basis to provide the user with remote video surveillance in a non-line-of-sight environment. Due to its low power consumption, the secure transmitter can be powered from a battery and used in fixed, mobile, or portable applications. Moreover, it can be housed in a rugged environmental housing milled from 6061-T6 Aluminum to withstand the harsh environments typically found at emergency incidents. These features make the secure transmitter ideal for application in Crisis Management and Law Enforcement Coordination activities.

FIG. 6 illustrates a block diagram of a personnel rapid deployment system in which a camera 610 and secure transmitter 620 are powered from a low voltage power supply 630, such as a 12V DC battery. The camera 610 may be a hand held, helmet mounted, or the like, and provide video information over one or more spectrums (visible, shortwave infrared, longwave infrared, etc.) A microphone or other sensor may be connected to the secure transmitter to collect additional information. The secure transmitter 620 may be belt-mounted or carried by backpack and the transmitter's antenna 640 may be helmet-mounted or extendable out of a backpack to provide maximum transmission range. User controls, such as channel selection, transmitted power level, audio gain, and user encryption key settings may be selected by means of a LCD screen located on, or connected to the secure transmitter. The LCD screen or other output device may also provide information to the user as well. The rapid deployment system allows the user to move through the environment while providing video imagery and audio to a command post for analysis.

The secure transmitter may also be used on Unmanned Ground Vehicles (UGVs) or Unmanned Aerial Vehicles (UAVs) to provide remote video surveillance of dangerous areas. When the invention is mounted to a UGV containing a video camera, the system can provide remote viewing in collapsed buildings, around corners, or other scenarios where it may not be safe to send a First Responder. Mounted to a tactical UAV the invention can provide aerial video imagery of an incident area to support tactical decision making.

The foregoing description has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A secure transmitter, comprising:
a data compression module having an input configured to receive video data, the data compression module operable to compress the received video data to a predefined bandwidth, wherein the data compression module outputs a transport stream comprising the bandwidth-compressed video data;
an encryption module having an input coupled to receive the transport stream and configured to apply an encryption algorithm thereto, the encryption module outputting, in response, an encrypted transport stream; and
a coded orthogonal frequency division multiplex module coupled to receive the encrypted transport stream and to produce, in response, an output signal comprising a plurality of sub-carriers, each sub-carrier modulated by data in the encrypted data stream.

2. The secure transmitter of claim 1, wherein the applied encryption algorithm comprises the Advanced Encryption Standard.

3. The secure transmitter of claim 1, wherein the data compression module is operable to compress the received data into an MPEG format.

4. The secure transmitter of claim 1, wherein the encryption module is configured to apply an advanced encryption standard to the compressed transport stream to produce the encrypted transport stream.

5. The secure transmitter of claim 4, wherein the received data further comprises encryption data, and wherein the encryption module is configured to apply, using the received encryption data, an advanced encryption standard to the received transport stream to produce the encrypted transport stream.

6. The secure transmitter of claim 5, wherein the received encryption data comprises a user selectable key and a network key.

7. The secure transmitter of claim 1, wherein the coded orthogonal frequency division multiplex module comprises:
a FEC encoder coupled to receive the encrypted transport stream, the FEC encoder operable to apply forward error correction to the encrypted transport stream, thereby producing an FEC-encoded transport stream;
a multi-carrier processor coupled to receive the FEC-encoded transport stream, the multi-carrier processor configured to modulate the FEC-encoded transport stream onto a plurality of substantially orthogonal sub-carrier signals to produce a respective plurality of modulated sub-carriers, the respective plurality of modulated sub-carriers defining a composite signal; and
a waveform generator coupled to receive and convert the composite signal into an output signal.

8. The secure transmitter of claim 7, wherein the multi-carrier processor applies an inverse fast fourier transform to generate the plurality of substantially orthogonal sub-carriers.

9. The secure transmitter of claim 7, wherein the FEC-encoded transport stream is modulated onto a plurality of the substantially orthogonal sub-carriers using phase shift key modulation.

10. The secure transmitter of claim 9, wherein the phase shift key modulation comprises quadrature phase shift key modulation.

11. The secure transmitter of claim 7, wherein the FEC-encoded transport stream is modulated onto a plurality of substantially orthogonal sub-carriers using amplitude modulation.

12. The secure transmitter of claim 11, wherein the amplitude modulation comprises QAM-16.

13. The secure transmitter of claim 11, wherein the amplitude modulation comprises QAM-64.

14. The secure transmitter of claim 7, wherein the plurality of sub-carriers comprises at least 250 sub-carriers.

15. The secure transmitter of claim 7, wherein the plurality of sub-carriers comprises 512 sub-carriers.

16. The secure transmitter of claim 7, wherein the plurality of sub-carriers comprises 1,705 sub-carriers.

17. The secure transmitter of claim 7, wherein the plurality of sub-carriers comprises 6,817 sub-carriers.

18. The secure transmitter of claim 7, wherein the output signal comprises a signal within the frequency range of 1 GHz to 6 GHz.

19. The secure transmitter of claim 7, further comprising a transmit module, the transmit module comprising:
a mixer coupled to receive the output signal, the mixer operable to mix the output signal with a second carrier signal to produce a second output signal; and
a power amplifier coupled to receive the second output signal, the power amplifier operable to amplify and transmit the second output signal to one or more secure receivers.

20. The secure transmitter of claim 18, wherein the second output signal comprises a signal within the frequency range of 1 GHz to 6 GHz.

21. A method of processing data for secure transmission, comprising:
receiving video data to be securely transmitted;
compressing the received video data to a fraction of its original bandwidth to produce a transport stream;
encrypting, using an encryption algorithm, the transport stream into an encrypted transport stream;
modulating the encrypted transport stream onto a plurality of substantially orthogonal sub-carriers using coded orthogonal frequency division multiplexing, wherein data of the encrypted transport stream are modulated onto different sub-carriers;
combining the collective plurality of modulated sub-carriers into a composite signal; and
converting the composite signal into an output signal.

22. The method of claim 21, wherein the encryption algorithm comprises the Advanced Encryption Standard.

23. The method of claim 21, wherein receiving data comprises receiving encryption data.

24. The method of claim 21, wherein compressing the received data comprises compressing the received data using a MPEG standard.

25. The method of claim 23, wherein the received encryption data comprises a user-selectable key, and a network key, and wherein encrypting the transport stream comprises using an advanced encrypted standard-based algorithm to encrypt the transport stream into an encrypted transport stream.

26. The method of claim 21, wherein modulating the encrypted transport stream onto a plurality of substantially orthogonal sub-carriers comprises phase shift key modulation.

27. The method of claim 26, wherein modulating the encrypted transport stream onto a plurality of substantially orthogonal sub-carriers comprises quadrature phase shift key modulation.

28. The method of claim 21, wherein modulating the encrypted transport stream onto a plurality of substantially orthogonal sub-carriers comprises amplitude modulation.

29. The method of claim 28, wherein modulating the encrypted transport stream onto a plurality of substantially orthogonal sub-carriers comprises QAM-16.

30. The method of claim 28, wherein modulating the encrypted transport stream onto a plurality of substantially orthogonal sub-carriers comprises QAM-64.

31. The method of claim 21, further comprising mixing the output signal with a second carrier signal to produce a second output signal.

32. A secure transmitter, comprising:
a data compression module having an input configured to receive data, the data compression module operable to compress the received data to a predefined bandwidth, wherein the data compression module outputs a transport stream comprising the bandwidth-compressed data;
an encryption module having an input coupled to receive the transport stream and configured to apply an encryption scheme thereto, the encryption module applying the Advanced Encryption Standard to the received transport stream and outputting, in response, an encrypted transport stream; and
a coded orthogonal frequency division multiplex module coupled to receive the encrypted transport stream and to produce, in response, an output signal comprising a plurality of sub-carriers, each sub-carrier modulated by data in the encrypted data stream.

33. The secure transmitter of claim 32, wherein the received data comprises video data.

34. The secure transmitter of claim 33, wherein the received data further comprises audio data.

35. The secure transmitter of claim 32, wherein the data compression module is operable to compress the received data into an MPEG format.

36. The secure transmitter of claim 32, wherein the received data comprises encryption data, and wherein the encryption module is configured to apply, using the received encryption data, an advanced encryption standard to the received transport stream to produce the encrypted transport stream.

37. The secure transmitter of claim 36, wherein the received encryption data comprises a user selectable key and a network key.

38. The secure transmitter of claim 32, wherein the coded orthogonal frequency division multiplex module comprises:
a FEC encoder coupled to receive the encrypted transport stream, the FEC encoder operable to apply forward error correction to the encrypted transport stream, thereby producing an FEC-encoded transport stream;
a multi-carrier processor coupled to receive the FEC-encoded transport stream, the multi-carrier processor configured to modulate the FEC-encoded transport stream onto a plurality of substantially orthogonal sub-carrier signals to produce a respective plurality of modulated sub-carriers, the respective plurality of modulated sub-carriers defining a composite signal; and
a waveform generator coupled to receive and modulate the composite signal onto a first carrier signal to produce, in response, an output signal.

39. The secure transmitter of claim 38, wherein the multi-carrier processor applies an inverse fast fourier transform to generate the plurality of substantially orthogonal sub-carriers.

40. The secure transmitter of claim 38, wherein the FEC-encoded transport stream is modulated onto a plurality of the substantially orthogonal sub-carriers using phase shift key modulation.

41. The secure transmitter of claim 40, wherein the phase shift key modulation comprises quadrature phase shift key modulation.

42. The secure transmitter of claim 38, wherein the FEC-encoded transport stream is modulated onto a plurality of substantially orthogonal sub-carriers using amplitude modulation.

43. The secure transmitter of claim 42, wherein the amplitude modulation comprises QAM-16.

44. The secure transmitter of claim 43, wherein the amplitude modulation comprises QAM-64.

45. The secure transmitter of claim 38, wherein the plurality of sub-carriers comprises at least 500 sub-carriers.

46. The secure transmitter of claim 38, wherein the output signal comprises a signal within the frequency range of 1 GHz to 6 GHz.

47. The secure transmitter of claim 38, further comprising a transmit module, the transmit module comprising:
a mixer coupled to receive the output signal, the mixer operable to mix the output signal with a second carrier signal to produce a second output signal; and
a power amplifier coupled to receive the second output signal, the power amplifier operable to amplify and transmit the second output signal to one or more secure receivers.

48. The secure transmitter of claim 47, wherein the second output signal comprises a signal within the frequency range of 1 GHz to 6 GHz.

49. A method of processing data for secure transmission, comprising:
receiving data to be securely transmitted;
compressing the received data to a fraction of its original bandwidth to produce a transport stream;
encrypting, using an Advanced Encrypted Standard-based algorithm, the transport stream into an encrypted transport stream;
modulating the encrypted transport stream onto a plurality of substantially orthogonal sub-carriers using coded orthogonal frequency division multiplexing, wherein data of the encrypted transport stream are modulated onto different sub-carriers;
combining the collective plurality of modulated sub-carriers into a composite signal; and
converting the composite signal into an output signal.

50. The method of claim 49, wherein receiving data comprises receiving video data.

51. The method of claim 49, wherein receiving data comprises receiving encryption data.

52. The method of claim 49, wherein compressing the received data comprises compressing the received data using a MPEG standard.

53. The method of claim 51, wherein the received encryption data comprises a user-selectable key, and a network key, and wherein encrypting the transport stream comprises using an advanced encrypted standard-based algorithm to encrypt the transport stream into an encrypted transport stream.

54. The method of claim 49, wherein modulating the encrypted transport stream onto a plurality of substantially orthogonal sub-carriers comprises phase shift key modulation.

55. The method of claim 54, wherein modulating the encrypted transport stream onto a plurality of substantially orthogonal sub-carriers comprises quadrature phase shift key modulation.

56. The method of claim 49, wherein modulating the encrypted transport stream onto a plurality of substantially orthogonal sub-carriers comprises amplitude modulation.

57. The method of claim 56, wherein modulating the encrypted transport stream onto a plurality of substantially orthogonal sub-carriers comprises QAM-16.

58. The method of claim 56, wherein modulating the encrypted transport stream onto a plurality of substantially orthogonal sub-carriers comprises QAM-64.

59. The method of claim 49, further comprising mixing the output signal with a second carrier signal to produce a second output signal.
